(19) United States
(12) Patent Application Publication
(10) Pub. No.: US 2015/0302208 A1
(43) Pub. Date: Oct. 22, 2015

(54) TRIGGER SIGNAL GENERATION APPARATUS AND METHOD

(71) Applicant: ELECTRONICS AND TELECOMMUNICATIONS RESEARCH INSTITUTE, Daejeon (KR)

(72) Inventors: Yongdae KIM, Daejeon (KR); Seon-yeong PARK, Daejeon (KR); Hee Bong CHOI, Daejeon (KR); Haeng Seok KO, Daejeon (KR); Sangwoo PARK, Daejeon (KR)

(21) Appl. No.: 14/475,230

(22) Filed: Sep. 2, 2014

(30) Foreign Application Priority Data
Apr. 22, 2014 (KR) 10-2014-0047871

(51) Int. Cl. G06F 21/60

(52) U.S. Cl. CPC G06F 21/60

(57) ABSTRACT

An apparatus and method that generate a trigger signal required for side channel analysis by analyzing the data of a smart card cryptographic module in real time. In the trigger signal generation method, a data input/output signal of a cryptographic module is monitored in real time. A preset section in the data input/output signal is analyzed. A reference signal is generated using the data input/output signal and a signal obtained from results of analysis of the preset section, and a trigger signal is generated using the reference signal.

### CROSS REFERENCE TO RELATED APPLICATION

This application claims the benefit of Korean Patent Application No. 10-2014-0047871, filed Apr. 22, 2014, which is hereby incorporated by reference in its entirety into this application.

### BACKGROUND OF THE INVENTION

1. Technical Field

The present invention relates generally to a trigger signal generation apparatus and method and, more particularly, to an apparatus and method that generate a trigger signal required for side channel analysis by analyzing the data of a smart card cryptographic module in real time.

2. Description of the Related Art

Side channel analysis technology was initially introduced in 1999, and has been developed to date in the form of various types of schemes. Among these various types of schemes, a side channel analysis method using correlation coefficients has been widely used.

With the exception of Simple Power Analysis (SPA), side channel analysis requires the measurement of a large number of waveforms. Upon measuring waveforms, the most important thing that is needed is a trigger signal required to determine the location at which a waveform is measured. Here, during the execution of a target process (for example, encryption), waveforms need to be measured.

In the past, a scheme for independently generating a trigger signal within a cryptographic module was used. However, such a scheme is problematic in that it is unusable when the cryptographic module cannot be controlled.

As another scheme, Korean Patent Application Publication No. 10-2011-0018988 entitled “Power signal measurement and trigger generation apparatus and method for side channel analysis” discloses technology for analyzing and verifying a device card equipped with a cryptographic algorithm with respect to generated side channels through the use of a universal card reader. In detail, the trigger generation unit of the power signal measurement and trigger generation apparatus for side channel analysis utilizes a scheme for individually storing trigger data and transfer rate information, comparing an input/output signal with stored trigger data, and generating a trigger signal if, as a result of the comparison, they are identical to each other. However, this technology is disadvantageous in that, in order to compare an input/output signal with stored trigger data, memory is required, and a user needs to know in advance the input/output which a cryptographic module will have. Further, such technology is disadvantageous in that, unless the user designates trigger data, the scheme cannot be used.

### SUMMARY OF THE INVENTION

Accordingly, the present invention has been made keeping in mind the above problems occurring in the prior art, and an object of the present invention is to provide an apparatus and method that generate a trigger signal at a suitable location by analyzing the data of a smart card cryptographic module in real time.

In accordance with an aspect of the present invention to accomplish the above object, there is provided a trigger signal generation method, including monitoring a data input/output signal of a cryptographic module in real time; analyzing a preset section in the data input/output signal; and generating a reference signal using the data input/output signal and a signal obtained from results of analysis of the preset section, and generating a trigger signal using the reference signal.

Monitoring the data input/output signal may be configured such that the data input/output signal includes a first signal having a head of an Application Data Unit (APDU), which is a signal indicating that data is input to the cryptographic module, and an acknowledgement (ACK) signal for data output, a second signal indicating that plaintext data to be encrypted is input to the cryptographic module, and a third signal indicating that a data output signal is output from the cryptographic module.

Generating the trigger signal may include checking, in real time, input of data of a head corresponding to the signal obtained from the results of analysis of the preset section, setting the reference signal from “1” to “0” if the data of the head is input, and resetting the reference signal to “1” if input of the data of the head has been completed and an ACK signal for data output is maintained fora predetermined period of time.

The reference signal may be set from “1” to “0” if plaintext data corresponding to subsequent data of the head is input, and is reset to “1” if a data output signal of the cryptographic module is maintained for a predetermined period of time.

Generating the trigger signal may include generating a signal, having a component opposite to that of a section corresponding to plaintext data of the reference signal, as the trigger signal.

In accordance with another aspect of the present invention to accomplish the above object, there is provided a trigger signal generation apparatus, including a monitoring unit for monitoring a data input/output signal of a cryptographic module in real time; an analysis unit for analyzing a preset section in the data input/output signal; and a generation unit for generating a reference signal using the data input/output signal and a signal obtained from results of analysis of the preset section, and generating a trigger signal using the reference signal.

The data input/output signal may include a first signal having a head of an Application Data Unit (APDU), which is a signal indicating that data is input to the cryptographic module, and an acknowledgement (ACK) signal for data output, a second signal indicating that plaintext data to be encrypted is input to the cryptographic module, and a third signal indicating that a data output signal is output from the cryptographic module.

The analysis unit may be configured to analyze a section ranging from a time at which plaintext data is input to the cryptographic module to a time immediately before a data output signal is output from the cryptographic module.

The generation unit may be configured to check, in real time, input of data of a head corresponding to the signal obtained from the results of analysis of the preset section, set the reference signal from “1” to “0” if the data of the head is input, and reset the reference signal to “1” if input of the data of the head has been completed and an ACK signal for data output is maintained for a predetermined period of time.

The reference signal may be set from “1” to “0” if plaintext data corresponding to subsequent data of the head is input, and may be reset to “1” if a data output signal of the cryptographic module is maintained for a predetermined period of time.

The generation unit may generate a signal, having a component opposite to that of a section corresponding to plaintext data of the reference signal, as the trigger signal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a configuration diagram schematically showing a trigger signal generation apparatus according to an embodiment of the present invention;

FIG. 2 is a reference diagram showing the data input/output of a smart card cryptographic module according to an embodiment of the present invention;

FIG. 3 is a diagram showing the data input/output signal of a smart card cryptographic module according to an embodiment of the present invention;

FIG. 4 is a diagram showing the data input signal of a smart card cryptographic module according to an embodiment of the present invention;

FIG. 5 is a diagram showing a signal generated based on a data input/output signal and a data input signal according to an embodiment of the present invention;

FIG. 6 is a diagram showing a trigger signal generated by a trigger signal generation apparatus according to an embodiment of the present invention; and

FIG. 7 is a flowchart showing a trigger signal generation method according to an embodiment of the present invention.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clearer.

Hereinafter, a trigger signal generation apparatus and method according to embodiments of the present invention will be described in detail with reference to the attached drawings.

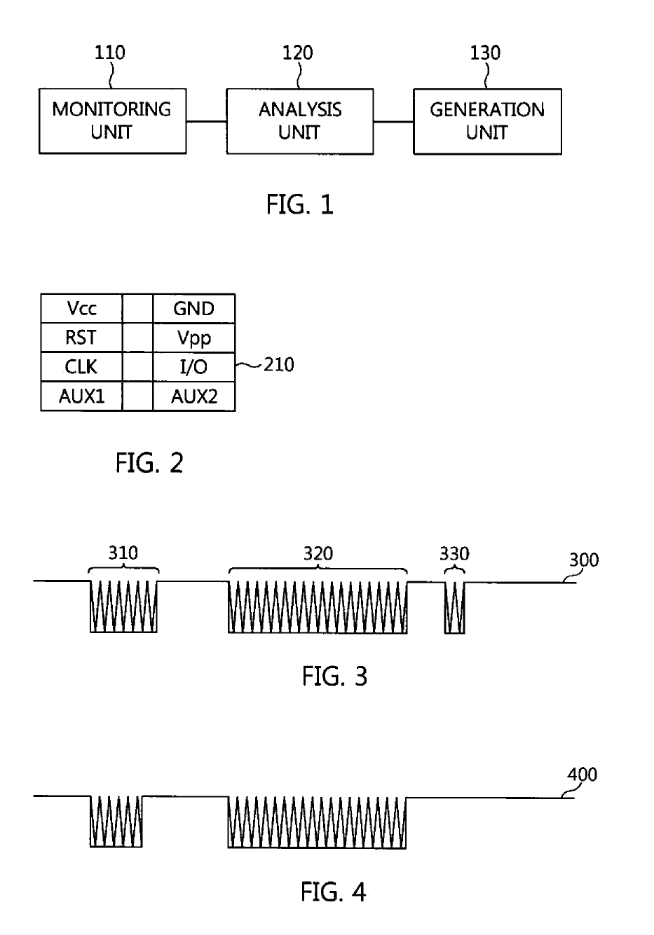

FIG. 1 is a diagram schematically showing a trigger signal generation apparatus according to an embodiment of the present invention. FIG. 2 is a reference diagram showing a smart card cryptographic module according to an embodiment of the present invention.

Referring to FIG. 1, a trigger signal generation apparatus includes a monitoring unit 110, an analysis unit 120, and a generation unit 130.

As shown in FIG. 2, in the smart card cryptographic module, the input/output of data is performed using a single port (I/O) 210.

The smart card cryptographic module transfers a data input/output signal in a half-duplex manner on an Application Data Unit (APDU) basis.

The monitoring unit 110 monitors in real time the data input/output signal of the smart card cryptographic module.

The analysis unit 120 analyzes the results, of monitored by the monitoring unit 110, that is, the data input/output signal. Here, the data input/output signal is shown in FIG. 3.

Referring to FIG. 3, a data input/output signal 300 includes a first signal 310 having the head of an APDU, which is a signal indicating that data is input to the cryptographic module, and an acknowledgement (ACK) signal for data output, a second signal 320 indicating that plaintext data to be encrypted is input to the cryptographic module, and a third signal 330 indicating that a data output signal (software data) is output from the cryptographic module.

The analysis unit 120 analyzes a section ranging from the time at which plaintext data is input to the cryptographic module to the time immediately before the data output signal (software data) is output from the cryptographic module, in the data input/output signal 300 shown in FIG. 3.

Generally, the input of data to the smart card is frequently performed by a Personal Computer (PC), and thus a data input signal may be easily obtained.

FIG. 4 is a diagram showing the head and plaintext data of the data input signal 400, that is, APDU, of the smart card cryptographic module.

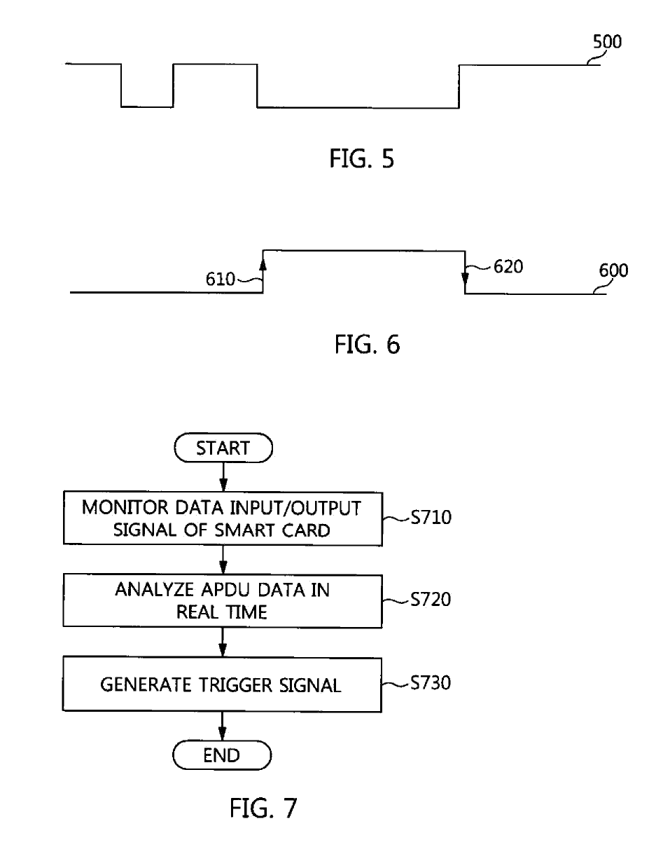

The generation unit 130 generates a reference signal 500 such as that shown in FIG. 5 using the data input/output signal 300, such as that shown in FIG. 3, and the data input signal (head and plaintext data) 400, such as that shown in FIG. 4, and generates a trigger signal using the reference signal. Here, the data input signal shown in FIG. 4 may be obtained from the results of analysis by the analysis unit 120.

The generation unit 130 generates the reference signal, such as that shown in FIG. 5, as follows.

The input of data of the head is checked in real time, so that if the head data is input, the signal of FIG. 5 is set to “0”, and so that if the input of the head data has been completed, and the ACK signal for the data output is maintained for a predetermined period of time, the signal of FIG. 5 is reset to “1.” Here, the predetermined period of time may be changed according to the transfer rate of the data and is not limited to a specific value. Further, when plaintext data corresponding to subsequent data is input, the signal of FIG. 5 is set to “0.” When the data output signal of the cryptographic module is maintained for a long period of time, the signal of FIG. 5 is reset to “1”.

Next, the generation unit 130 generates a trigger signal such as that shown in FIG. 6, using the reference signal such as that shown in FIG. 5. That is, the trigger signal may correspond to a signal having a component opposite to that of the section ranging from the time at which plaintext data of the reference signal shown in FIG. 5 is input to the time before the data output signal of the cryptographic module is maintained for a predetermined period of time, that is, the section corresponding to the plaintext data, and is not limited to such a signal.

Referring to FIG. 6, a trigger signal includes a rising edge (positive edge) 610 and a falling edge (negative edge) 620.

In this way, the present invention may generate the trigger signal and detect a trigger using the positive edge 610 and the negative edge 620 of the trigger signal, thus enabling waveforms to be measured in an encryption procedure.

For example, when an encryption procedure differs according to the value of plaintext data that is used and the time required for encryption varies, a time interval between the positive edge 610 and the negative edge 620 varies with the data that is processed at each time. In that case, even if the time required for the encryption procedure varies depending on the plaintext data, a portion corresponding to the target for waveform collection can be stably obtained in such a way that, when a fore portion of the encryption procedure is desired to be a target, the positive edge 610 of the trigger signal is used, whereas when only a latter portion of the encryption procedure is desired to be the target, the negative edge 620 of the trigger signal is used.

Below, a method of generating a trigger signal required for side channel analysis by analyzing the data of a smart card cryptographic module in real time will be described in detail with reference to FIG. 7.

FIG. 7 is a flowchart showing a trigger signal generation method according to an embodiment of the present invention.

First, the smart card cryptographic module transfers a data input/output signal in a half-duplex manner on an Application Data Unit (APUD) basis.

Referring to FIG. 7, the trigger signal generation apparatus monitors the data input/output signal of the smart card cryptographic module in real time at step S710.

The trigger signal generation apparatus analyzes a data input/output signal corresponding to the results, monitored at step S710, at step S720.

Referring to FIG. 3, the data input/output signal 300 includes a first signal 310 having the head of an APDU, which is a signal indicating that data is input to the cryptographic module, and an acknowledgement (ACK) signal for data output, a second signal 320 indicating that plaintext data to be encrypted is input to the cryptographic module, and a third signal 330 indicating that a data output signal (software data) is output from the cryptographic module.

At step S720, the trigger signal generation apparatus analyzes a section ranging from the time at which plaintext data is input to the cryptographic module to the time immediately before a data output signal is output from the cryptographic module, in the data input/output signal shown in FIG. 3.

The trigger signal generation apparatus generates a reference signal, such as that shown in FIG. 5, using the data input/output signal of FIG. 3, which is obtained from the results analyzed at step S720, and the data input signal of FIG. 4 (head and plaintext data), and generates a trigger signal using the reference signal at step S730. Here, a procedure for generating the reference signal of FIG. 5 will be described below.

The input of data of the head is checked in real time, so that if the data of the head is input, the signal of FIG. 5 is set to “0”, and so that if the input of the head data has been completed, and the ACK signal for data output is maintained for a predetermined period of time, the signal of FIG. 5 is reset to “1.” Here, the predetermined period of time may be changed according to the transfer rate of the data and is not limited to a specific value. Further, when plaintext data corresponding to subsequent data is input, the signal of FIG. 5 is set to “0.” When the data output signal of the cryptographic module is maintained for a long period of time, the signal of FIG. 5 is reset to “1”.

In this way, the trigger signal generation method according to the embodiment of the present invention analyzes the data of the smart card cryptographic module in real time, and generates a trigger signal at a suitable location, thus stably acquiring waveforms that are used for side channel analysis.

In accordance with the present invention, the trigger signal generation apparatus and method may analyze the data of a smart card cryptographic module in real time, and generate a trigger signal at a suitable location, thus stably acquiring waveforms that are used for side channel analysis.

Further, the trigger signal generation apparatus and method according to the embodiments of the present invention may be implemented using inexpensive hardware compared to other schemes.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. A trigger signal generation method, comprising:
monitoring a data input/output signal of a cryptographic module in real time;
analyzing a preset section in the data input/output signal; and
generating a reference signal using the data input/output signal and a signal obtained from results of analysis of the preset section, and generating a trigger signal using the reference signal.

2. The trigger signal generation method of claim 1, wherein monitoring the data input/output signal is configured such that the data input/output signal includes a first signal having a head of an Application Data Unit (APDU), which is a signal indicating that data is input to the cryptographic module, and an acknowledgement (ACK) signal for data output, a second signal indicating that plaintext data to be encrypted is input to the cryptographic module, and a third signal indicating that a data output signal is output from the cryptographic module.

3. The trigger signal generation method of claim 1, wherein analyzing the preset section comprises analyzing a section ranging from a time at which plaintext data is input to the cryptographic module to a time immediately before a data output signal is output from the cryptographic module.

4. The trigger signal generation method of claim 1, wherein generating the trigger signal comprises checking, in real time, input of data of a head corresponding to the signal obtained from the results of analysis of the preset section, setting the reference signal from “1” to “0” if the data of the head is input, and resetting the reference signal to “1” if input of the data of the head has been completed and an ACK signal for data output is maintained for a predetermined period of time.

5. The trigger signal generation method of claim 4, wherein the reference signal is set from “1” to “0” if plaintext data corresponding to subsequent data of the head is input, and is reset to “1” if a data output signal of the cryptographic module is maintained for a predetermined period of time.

6. The trigger signal generation method of claim 1, wherein generating the trigger signal comprises generating a signal, having a component opposite to that of a section corresponding to plaintext data of the reference signal, as the trigger signal.

7. A trigger signal generation apparatus, comprising:
a monitoring unit for monitoring a data input/output signal of a cryptographic module in real time;
an analysis unit for analyzing a preset section in the data input/output signal; and
a generation unit for generating a reference signal using the data input/output signal and a signal obtained from results of analysis of the preset section, and generating a trigger signal using the reference signal.

8. The trigger signal generation apparatus of claim 7, wherein the data input/output signal includes a first signal having a head of an Application Data Unit (APDU), which is a signal indicating that data is input to the cryptographic module, and an acknowledgement (ACK) signal for data output, a second signal indicating that plaintext data to be encrypted is input to the cryptographic module, and a third signal indicating that a data output signal is output from the cryptographic module.

9. The trigger signal generation apparatus of claim 7, wherein the analysis unit is configured to analyze a section ranging from a time at which plaintext data is input to the cryptographic module to a time immediately before a data output signal is output from the cryptographic module.

10. The trigger signal generation apparatus of claim 7, wherein the generation unit is configured to check, in real time, input of data of a head corresponding to the signal obtained from the results of analysis of the preset section, set the reference signal from “1” to “0” if the data of the head is input, and reset the reference signal to “1” if input of the data of the head has been completed and an ACK signal for data output is maintained for a predetermined period of time.

11. The trigger signal generation method of claim 10, wherein the reference signal is set from “1” to “0” if plaintext data corresponding to subsequent data of the head is input, and is reset to “1” if a data output signal of the cryptographic module is maintained for a predetermined period of time.

12. The trigger signal generation method of claim 7, wherein the generation unit generates a signal, having a component opposite to that of a section corresponding to plaintext data of the reference signal, as the trigger signal.
